(19) United States
(12) Patent Application Publication
(10) Pub. No.: US 2023/0219099 A1
(43) Pub. Date: Jul. 13, 2023

(54) SHREDDING ARRANGEMENT WITH INFEED ROLLER

(71) Applicant: VECOPLAN AG, Bad Marienberg (DE)

(72) Inventors: Martin BALDUS, Rotenhain (DE); Bastian LEPACK, Lautzenbruecken (DE); Stefan MENZEL, Herschbach (DE)

(21) Appl. No.: 17/819,723

(22) Filed: Aug. 15, 2022

(30) Foreign Application Priority Data
Aug. 16, 2021 (DE) 10 2021 121 235.9

(51) Int. Cl. B02C 18/22; B02C 18/24

(52) U.S. Cl. CPC B02C 18/2283; B02C 18/24

(57) ABSTRACT

A shredding arrangement for shredding material to be shredded, such as household waste, industrial waste, plastics, wood, paper and/or biomass, comprising a shredding device, which is arranged on a machine frame, and a supply device having at least one infeed roller drivable to rotate using an associated drive device for supplying the material to be shredded to the shredding device. The shredding arrangement is distinguished in that the infeed roller is configured to accommodate the associated drive device, and the drive device has an electric motor, gearing, and a flexible coupling.

### FIELD

The invention relates to a shredding arrangement for shredding material to be shredded, such as household waste, industrial waste, plastics, wood, paper and/or biomass, comprising a machine frame, on which a shredding device is arranged, and a supply device having at least one infeed roller drivable to rotate using an associated drive device for supplying the material to be shredded to the shredding device.

### BACKGROUND

Such shredding arrangements are well known in the field and may be of a design adapted to the material to be shredded. In this case, the drive device, which drives the infeed roller to rotate and so supply material to be shredded to the shredding device, is conventionally flange-mounted on an axial end face of the infeed roller. Depending on the embodiment, the drive device of one or more such infeed rollers may for example comprise an electric motor or a hydraulic motor. A shredding apparatus of the above type, here for shredding sheet-form material to be shredded, is described for example in published patent application DE102016107525A1.

A major disadvantage of such conventional shredding arrangements with a drive device arranged at the end face of the respective infeed roller consists in the fact that the structural width of the shredding arrangement is increased in the infeed region, which prevents a compact construction. Depending on the embodiment, such drive components generally arranged outside the machine frame constitute an additional safety risk, frequently requiring corresponding protective measures, under certain circumstances of a structural type, which may increase both the manufacturing effort and the installation and maintenance effort for such a conventional shredding arrangement.

### SUMMARY

In this respect, the object of the present invention is to modify a conventional shredding arrangement in such a way that the described disadvantages caused by the drive of the infeed roller may be remedied at least in part.

The shredding arrangement according to the invention for shredding material to be shredded has a shredding device which is arranged, in particular bearing-mounted, on a machine frame, and a supply device for supplying the material to be shredded to the shredding device and having at least one infeed roller which can be driven to rotate by an associated drive device. The shredding arrangement according to the invention is distinguished in that the infeed roller is configured to accommodate the associated drive device, and the drive device is in this respect arranged within the infeed roller and has an electric motor, a gearing, and a flexible coupling.

The concept underlying the invention is to further develop a conventional shredding arrangement by configuring the drive device of the at least one infeed roller of the supply device in such a way that it can be arranged within the at least one infeed roller, so allowing a compact construction with a simultaneous reduction in possible safety risks which may be caused by a drive device otherwise fitted externally to the drive roller. The arrangement of the drive device, comprising electric motor, gear train and flexible coupling, may here in particular be such that said components of the drive device or the drive device itself are arranged fully within the infeed roller, thereby also resulting in greater flexibility with regard to possible encapsulation of the supply device due to the omission of further feedthroughs such as for example for drive shafts, drive chains, hydraulic distributors or hydraulic couplings when using hydraulic drives.

The shredding arrangement according to the invention may provide improved design options in order to prevent dirt such as dust generated during the shredding operation from escaping into the surrounding environment. In addition, the drive device arranged within the infeed roller can be protected from external influences. Furthermore, the provision of a flexible coupling in the drive train for the infeed roller may enable equalization of axial and/or radial imbalances and compensation of manufacturing tolerances within the drive device or the drive train of the infeed roller. Furthermore, impacts and/or torque peaks arising during operation of the shredding arrangement according to the invention may for example be moderated or cushioned by using at least one resilient intermediate member or a plurality of resilient intermediate members, which bring a component arranged on the coupling input side and a component arranged on the coupling output side into operative connection, such that particular, possibly impact-sensitive, drive components may be inserted within the drive device of the infeed roller, for example a complex gear train such as an epicyclic gear train, so resulting in a particularly compact construction of the drive device of the infeed roller.

The shredding arrangement according to the invention may be configured for different shredding device designs. This shredding device may for example have a shredding rotor, which is bearing-mounted on the machine frame so as to be rotatable about the rotor shaft thereof and has at its circumference at least one or a plurality of shredding tools for shredding the material to be shredded. Provision may for example be made for a plurality of shredding tools to be fastened to the rotor next to one another along the longitudinal axis of the rotor, possibly spaced relative to one another in the longitudinal direction of the rotor. In the case of a woodchipper, for example for shredding tree trunks, the shredding rotor may for example have just one individual tool. It is also possible for the shredding device according to the invention to have stationary blades or cutter strips which interact with the at least one shredding tool arranged on the rotating shredding rotor to shred the material to be shredded. Furthermore, a shredding device according to the invention may also have a plurality of shredding rotors, which may for example be arranged parallel to one another with regard to their axis of rotation, wherein the shredding tools of the mutually adjacently arranged shredding rotors interact to shred the material to be shredded. The precise configuration of the shredding tool(s) may be specifically adapted to the material to be shredded.

Further features and further developments according to the invention of the shredding arrangement according to the invention are indicated in the general description, the figures, the descriptions of the figures and the subclaims.

Provision may be made according to the invention for the at least one infeed roller to have a roller base member of hollow-cylindrical type accommodating the associated drive device, wherein the term “of hollow-cylindrical type” should be interpreted broadly and the roller base member does not in every event have to be of rotationally symmetrical configuration, but rather may deviate from pure cylindrical symmetry. In this respect, this roller base member may in particular be of rotationally symmetrical configuration but is not limited to this.

In particular, the roller base member may have protruding portions on its internal circumferential surface, for example in the form of a bearing faces, on which bearing elements are supported, or other forms, for example at least one welded-on element for providing an operative connection with the gear train, in order to drive the roller base member.

Provision may be made for the roller base member to have texturing on its external circumferential surface to improve an operative connection between the infeed roller and the material to be shredded on supply of the material to be shredded to the shredding device, for example in the form of radial projections such as teeth, with which the infeed roller engages in the material to be shredded to supply the material to be shredded toward the shredding device during rotational motion of the infeed roller. These engaging teeth may for example be arranged on the external circumferential surface of a sleeve which may be fastened with its internal circumferential surface to the external circumferential surface of the roller base member. In this respect, the infeed roller may also comprise a plurality of radially successive sleeve elements, of which one may be the roller base member, in order to provide the described functionalities of the infeed roller both at its external circumferential surface and at its internal circumferential surface. It is moreover possible for a plurality of elements having the stated teeth, for example strip elements, to be mounted on the external circumferential surface of the roller base member, for example using screwing or welding, in order to texture the surface of the infeed roller to improve interaction between material to be shredded and infeed roller.

Depending on the embodiment, the invention may be configured with different flexible couplings, for example with a claw coupling, a strap-type coupling, a flexible disk coupling, a spring coupling, a flexible pin coupling, a tire coupling, a flexible flange coupling etc., which provide the advantage of equalizing axial and/or radial imbalances and compensating manufacturing tolerances within the drive device or the drive train. By using at least one or more flexible intermediate members, which bring a component arranged on the coupling input side and a component arranged on the coupling output side into operative connection, these flexible couplings moderate impacts and/or torque peaks arising during operation. Depending on the embodiment, displacements generated through compression or expansion or by torsion in these flexible intermediate members can be compensated within the drive train.

Particularly advantageously, a torsionally flexible coupling may be provided, in which flexible rubber elements are fastened between two radial flanges, which rubber elements transfer an operating torque from an input-side flange to an output-side flange of the coupling, in particular in an axially pluggable design, in which components of the flexible coupling, for example the two flanges, are arranged in axially pluggable manner to provide simpler mounting/removal of the coupling or substantially of the entire drive device arranged in the infeed roller.

To simplify mounting/removal of the drive device within the at least one infeed roller of the supply device of the shredding arrangement according to the invention, provision may be made for the motor shaft of the electric motor to be connected with the input side of the gearing, wherein the driven side of the gearing can be connected to the input side of the described flexible coupling and the coupling is joined on the driven side to the at least one infeed roller, to be set in rotation, of the supply device or connected with the latter.

In one embodiment of the invention, provision may also be made for the motor shaft of the electric motor to be joined to the input side of the flexible coupling, which is in turn connected on the output side with the input side of the gear train, wherein the output side of the gear train is coupled to the infeed roller or the hollow cylinder of the infeed roller, in order to transfer torque to the infeed roller.

Various gearings may be used to configure the shredding arrangement according to the invention. Compact gear trains, such as high ratio special gear trains, for example a strain wave gear train or a cycloidal gear train are suitable for configuring the shredding arrangement according to the invention. The use of a planetary gear train has proven particularly convenient, a plurality of constellations in turn being possible according to the invention. Provision may for example be made for the motor shaft of the electric motor to be connected with the input side of the planetary gear train, while the driven side of the gearing may be formed in one embodiment by the internal gear of the planetary gear train, and the drive side of the gearing may be formed by a sun gear of the planetary gear train, which may be coupled, as stated, to the motor shaft. In this embodiment, provision may be made for the planet carrier to be fixed. It is however also within the scope of the invention to provide, when using such an epicyclic gear train (planetary gear train), for the internal gear to be fixed to the housing of the gear train, while the sun gear is connected with the motor shaft of the electric motor and the planet carrier is connected as the output side of the gear train with the input side of the flexible coupling. As a person skilled in the art will recognize, depending on the embodiment, the gear train may be configured such that the highest possible torque is provided, especially on start-up of the roller.

In one particularly advantageous embodiment of the shredding arrangement according to the invention, the flexible coupling may have a first ring element or disk element, in particular in the form of a flange element, on the output side, which is fastened, in particular rigidly, for example using material bonding brought about by welding, to an internal circumferential surface of the cylinder-type roller base member and takes the form of a driver, wherein the flexible coupling may have a second ring element or disk element, in particular in the form of a flange, and the latter may be arranged on the driven side relative to the gearing. Provision may in this respect preferably be made for the first and second ring elements or disk elements to be in operative connection via at least one flexible coupling element for force and/or torque transmission. In this respect, provision may be made for the at least one flexible coupling element to be fastenable to one of the two ring elements or disk elements and to extend with a free end in particular roughly perpendicular to the axis of the ring element or disk element into an associated opening in the other of the two ring elements or disk elements to provide a circumferential form-fitting joint between the first and second ring elements or disk elements. The flexible coupling may preferably have a plurality of such flexible coupling elements, which may for example be of cylindrical construction. These coupling elements may be made from an elastomer material, in particular as a vulcanizate obtained from a natural and/or a silicone rubber.

Fastening of the first ring element or disk element of the flexible coupling to the inside of the roller base member may for example also be achieved by providing correspondingly arranged receiving points for rigidly fastening or rigidly receiving the first ring element or disk element, such that this may be screwed to the receiving point during assembly, for example using threaded bolts.

To provide a compact construction of the drive device and thus simplify a design in which it is arranged in particular completely in the interior of the roller base member of hollow-cylindrical type, provision may conveniently be made for the gearing to extend in places axially through the first ring element or disk element, formed as a driving element, of the flexible coupling. In one particularly convenient embodiment, provision may also be made for the gearing, in the installation position, to extend at least in places axially both through the first and through the second ring element of the flexible coupling, to achieve a particularly compact construction with the described advantages.

To support the moving portion of the at least one infeed roller relative to a stationary portion of the roller, provision may conveniently be made for a bearing support device extending axially into the roller base member to be arranged in each case in the region of longitudinal end portions of the roller base member, on which support device the roller base member is supported on its inside via a respective bearing device such as a plain bearing device, in such a way that the roller base member is arranged to perform a rotary motion relative to the bearing support devices. In this respect, provision may conveniently be made for the bearing device to provide axial play between the moving roller base member and the bearing support devices, while a substantially play-free bearing arrangement allowing the described rotary motion of the roller base member relative to the bearing support devices, preferably in the radial direction, may be provided. When designing a respective plain bearing, a lubricating film separating the parts moving relative to one another or indeed solid lubricants may conveniently be provided in the parts moving relative to one another, to prevent lubricant from escaping from the respective bearing device, whereby maintenance intervals of the drive device of the supply device of the shredding arrangement according to the invention may be extended. Provision may conveniently be made for a radial bearing, in particular configured as a plain bearing, to be provided on both the bearing support devices, wherein a thrust bearing is preferably additionally or integrally arranged on one of the two bearing support devices between the stationary bearing support devices and the roller base member moving relative thereto in order to absorb the operating forces and to provide the desired rotary motion of the bearing base member in relation to the stationary bearing support devices.

Provision may preferably be made for at least one of the two bearing support devices, in particular both of the bearing support devices, in each case to be configured as a bearing ring, which carries the respective bearing device to support the rotating roller base member relative to the respective bearing support device. In one particularly convenient embodiment of the shredding arrangement according to the invention, one of the bearing support devices may additionally be set up and configured to carry an assembly, comprising the electric motor, the gearing, and a gear-side ring element or disk element of the flexible coupling. Provision may in this respect be made for the assembly to be connectable by a detachable connection, for example a bolt joint, with this associated bearing support device, such that the assembly is removable as a unit from the roller base member by undoing the connection with the associated bearing support device, which may significantly simplify assembly and/or maintenance work. This applies in particular in the case of a flexible coupling which, as stated above, may be configured in such a way that mutually associated coupling components are configured to be axially pluggable. Provision may preferably be made for the assembly to be connected, for example screwed, together with the associated bearing support device axially in the region of the gearing. Through the stated coupling of the motor with the bearing support device, the latter may take for form of a torque support for the drive device.

To dissipate waste heat from the drive device, in particular the electric motor and/or the gearing, provision may conveniently be made for a fan device to be arranged and configured to move a cooling fluid, in particular air, axially through the roller base member with drive device accommodated therein. Provision may preferably be made for an air inlet to be arranged at one end face of the roller base member and an air outlet to be arranged at the other end face of the roller base member and for the fan device to be configured and arranged and arranged electrically controllably, to generate a predetermined air throughput, in particular as a function of an actual value of the motor power, through the roller base member in the axial direction. Provision may conveniently be made for air guide slots to be provided in the interior of the roller base member, for example on ring elements or disk elements of the flexible coupling and/or the bearing support devices, in order to guide the cooling fluid into the regions of the units generating waste heat within the roller base body and thus to dissipate the waste heat generated by the drive device.

Furthermore, the fan device may have at least one or more filter elements, for example in the form of fine-mesh grids or high-efficiency air filters, in the region of the at least one air inlet and/or in the region of the at least one air outlet, in order to prevent contamination of the drive device by particle-containing outside air and to stop particles, which may for example arise in the case of a defect or abrasion within the drive device, from escaping from the drive device into the operating room of the shredding arrangement.

The described arrangement of the drive device within a roller base member of the infeed roller in the shredding arrangement according to the invention is suitable in particular in those shredding arrangements in which the supply device has a rocker arranged swivelably on the machine frame, on which rocker the at least one infeed roller is rotatably arranged, since in the lateral end regions of such a rocker it is possible to dispense with the arrangement of a drive device associated with the infeed roller. Provision may for example be made for the supply device to have, in addition to the infeed rocker, on which an infeed roller is rotatably bearing-mounted, at least one further, generally a plurality of further infeed rollers. These further infeed rollers may provide, for example in the supply region, a lower portion, in the form of bottom infeed rollers, on which lower portion the material to be shredded rests, while the infeed roller of the rocker as upper infeed roller rests on the material to be shredded through the weight of the rocker, such that the material to be shredded is arranged between the lower infeed roller(s) and the at least one upper infeed roller and transported in the supply direction. In addition to the at least one upper infeed roller bearing-mounted on the rocker, at least one of the lower infeed rollers may also be driven for rotary motion, to move the material to be shredded in the supply direction.

In this respect, in the shredding arrangement according to the invention, the bearing support devices may, depending on the embodiment, be fastened non-rotatably to the machine frame or non-rotatably to an above-described rocker or infeed rocker of the supply device, wherein this rocker may be arranged movably about a swivel axis relative to the machine frame for adaptation of an infeed or supply gap to the material to be shredded, and wherein this gap may be formed between the upper infeed roller bearing-mounted on the rocker and the at least one lower infeed roller(s).

In such embodiments, in which the supply device has such a rocker, provision may be made for the swivel axis of the rocker, the axis of rotation of the upper infeed roller bearing-mounted on the rocker and/or the axis of rotation of the lower infeed roller(s) to be arranged parallel to one another, in particular roughly perpendicular to the supply device and roughly parallel to a shredding rotor axis.

This arrangement with an infeed rocker in the supply region of the shredding arrangement according to the invention makes it possible to configure side plates of the machine frame in the region of the rocker in such a way that side plate portions extending parallel to the supply direction are arranged which substantially prevent (partially) shredded material and/or material to be shredded from escaping from the shredding chamber in this region. The rocker may in this respect be arranged swivelably in the transverse direction between these side plate portions and lowerably therebetween in such a way that, when the rocker is an operational position, the axis of rotation of the infeed roller bearing-mounted on the rocker lies below the upper edge of the side plates. The described design means that the escape of material to be shredded or partially shredded material during operation of the shredding arrangement according to the invention is prevented or is significantly reduced in comparison with conventional shredding arrangements which have a rocker in the supply region, since no recess or slot running roughly perpendicular to the supply direction, as in conventional shredding arrangements, has to be provided in the associated side plate portions in the arrangement according to the invention to provide the swivel motion of the rocker, so that connection portions can be arranged for external flanging on of drive units of the infeed roller, for example in the form of drive chains or drive couplings.

For precise control of the movement of the at least one infeed roller, provision may conveniently be made for the electric motor to be powered by a frequency converter to provide an AC supply voltage with predetermined amplitude and frequency for establishing a predetermined speed of rotation and/or rotational acceleration of the infeed roller. In order to brake the at least one infeed roller in particular in generative operating situations, provision may conveniently be made for the frequency converter to have a braking resistor in a DC link circuit, which braking resistor may be connected at intervals in the link circuit in the manner of a chopper using an electrical switch, in order to reduce energy and so brake the infeed roller. In particular to provide high start-up torques, provision may conveniently be made for the electric motor to take the form of a servomotor. As explained above, the shredding device of the shredding arrangement according to the invention may comprise a shredding rotor driven by a further drive device, which shredding rotor has at least one shredding tool, in particular a plurality of shredding tools, at its circumference, wherein the shredding arrangement may have a control device which controls the drive device of the shredding rotor, which may for example take the form of a hydraulic drive or electric drive, and the drive device of the infeed roller for mutually coordinated supply and shredding of the material to be shredded.

### BRIEF DESCRIPTION OF THE DRAWINGS

The invention is explained hereinafter with reference to the accompanying figures through the description of an embodiment together with modifications, wherein:

FIG. 1 is a perspective partial view of a shredding arrangement configured according to the invention;

FIG. 2 is a side view of the shredding arrangement according to the invention of FIG. 1, omitting components to show the infeed mechanism;

FIG. 3 is a cross-sectional representation in longitudinal section of an infeed roller of the shredding arrangement of FIG. 1;

FIG. 4 is an isometric view of the infeed roller shown in FIG. 3 of the shredding arrangement of FIG. 1, but reflected in the vertical direction; and

FIG. 5 is a further isometric view of the infeed roller shown in FIGS. 3 and 4 of the shredding arrangement of FIG. 1.

### DETAILED DESCRIPTION

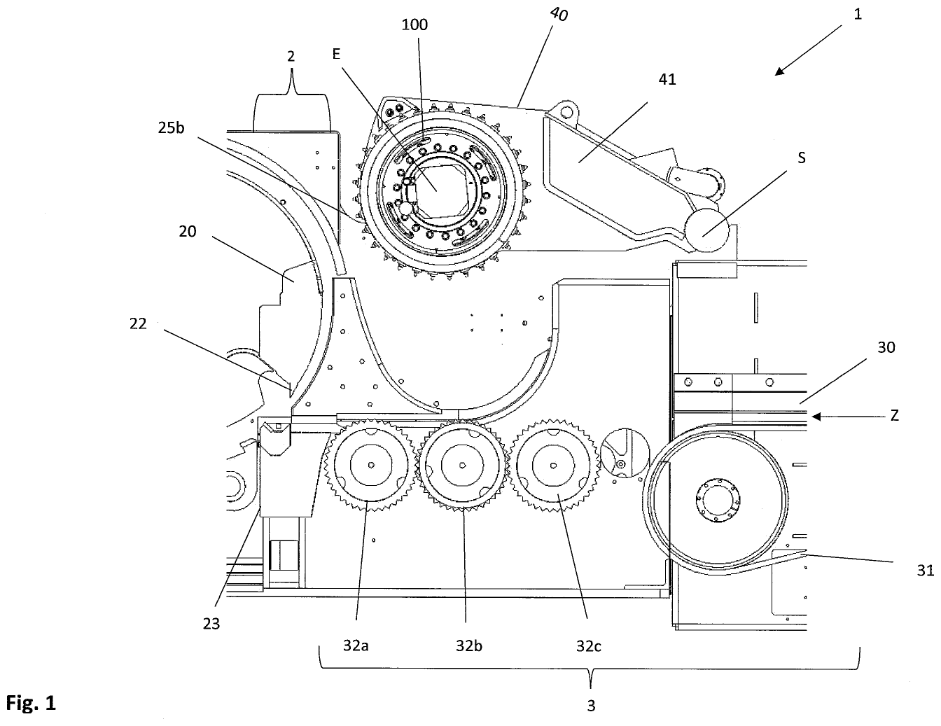

A respective shredding arrangement configured according to the invention may be specifically adapted to material to be shredded. A shredding arrangement according to the invention is described below which may be configured and set up to shred elongate objects of varying diameter such as tree trunks. FIG. 1 shows a detail representation of such a shredding arrangement 1 in side view, wherein components have been removed in part for the sake of clarity. The shredding arrangement 1 shown comprises a shredding device 2 with a shredding rotor 20, the rotor shaft of which, in the representation of FIG. 1, lies perpendicular to the plane of the drawing. The shredding rotor 20 here comprises a plurality of shredding tools 22 arranged at the circumference thereof, of which the representation of FIG. 1 shows just one individual tool. To supply the material to be shredded, the shredding arrangement 1 comprises a supply device 3, with a supply belt device 30, which is driven via a belt drive 31. The supply belt device 30 transfers the material to be shredded in supply direction Z, here perpendicular to the axis of the shredding rotor, to an infeed roller arrangement with a plurality of lower infeed rollers 32a,b,c, which have a common drive motor 33 and an upper infeed roller 100, which is bearing-mounted on an infeed rocker 40, which itself has a swivel axis S which here runs parallel to the axis of the shredding rotor 20 and furthermore parallel to the axis of rotation E of the upper infeed roller.

The infeed rocker 40 has a rocker housing 41 which, in the transverse direction, i.e. perpendicular to supply direction Z and parallel to the rotor shaft, is of such a dimension that it lies within the side plates 24, spaced in the transverse direction, of the shredding device, such that the rocker, loaded under its own weight in the drawing in FIG. 1, moves downward into the shredding chamber of the shredding device 2 defined by the side plates 24a,b until it rests against the supplied material to be shredded.

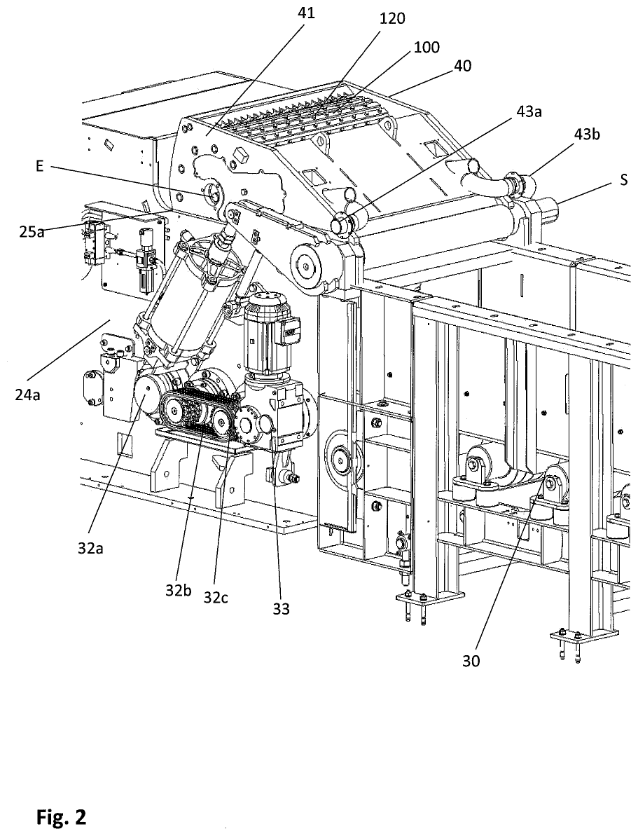

The lower infeed rollers 32a,b,c may accordingly form with the infeed roller 100 of the rocker 100 an infeed gap adapted automatically to the thickness of the material to be shredded. Since the drive of the infeed roller 100 bearing-mounted on the rocker housing 41 of the infeed rocker 40 is arranged in a manner still to be described within the roller body, the depicted design according to the invention of the shredding arrangement 1 allows operating situations in which the axis of rotation E of the upper infeed roller 100 lies below the upper edge 25a,b of the side plates 24a,b of the shredding device 2. This design is in particular clear from FIG. 2, in which an operational situation is shown in which the infeed rocker 40 dips into the shredding chamber delimited laterally by the side plates 24a,b, wherein it is possible for the axis of rotation E of the upper infeed roller 100 to move below the upper edge 25a,b of the side plates 24a,b of the machine frame.

As is clear in particular from FIGS. 1 and 2, the arrangement explained in greater detail below of the drive device of the upper infeed roller 100 within a roller base member means that no drive units are joined laterally to the upper infeed roller, which would otherwise make it necessary to provide a vertical slot or a vertical recess in the side plate portions 24a,b of the machine frame 23 to allow the infeed rocker 40 to dip sufficiently into the shredding chamber.

During operation of the shredding arrangement 1 according to the invention, the tree trunks are transported by the supply belt device 30 into the region of the infeed rollers 33a,b,c and 100, firstly by the first lower supply roller 33c in the supply direction toward the shredding rotor 20, then grasped by the lower infeed roller 33b and the upper infeed roller 100 bearing-mounted in the rocker 40 and transported further toward the shredding rotor 20. The infeed rocker 40 is in this case freely swivelable about the axis of rotation S thereof, such that the rocker rests with its weight on the material to be shredded and thus adjusts itself automatically to a varying trunk diameter, such that the tree trunk may be supplied irrespective of its diameter in a defined manner to the shredding rotor in supply direction Z.

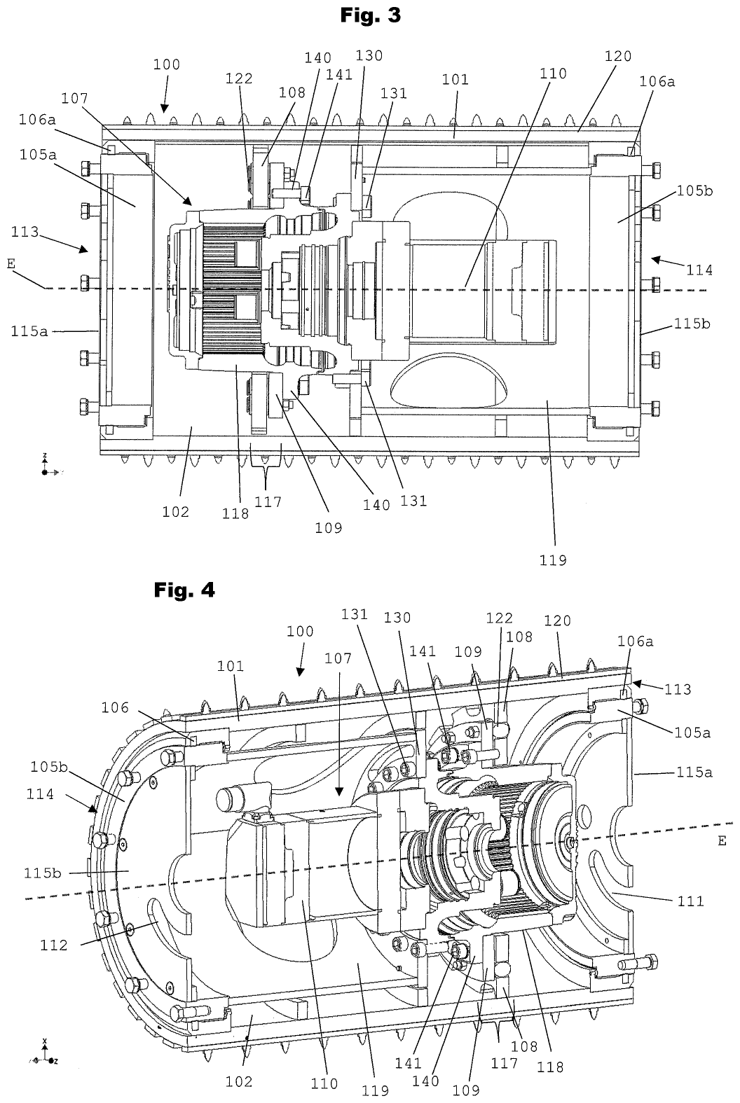

FIG. 3 shows a possible embodiment of the infeed roller 100 of the shredding arrangement 1 according to the invention of FIGS. 1 and 2 in longitudinal section along the axis of rotation E of the infeed roller. The infeed roller 100 may have a roller base member 101 which is here rotationally symmetrical, and on which there are arranged a circumferentially extending plurality of engaging strips 120, mounted on the external circumferential surface thereof and each comprising a plurality of radially extending spaced projections in the manner of teeth. Depending on the embodiment, the engaging strips 120 may be applied in materially bonded or form-fitting manner to the external circumferential surface of the roller base member 101. In another embodiment, provision may also be made for the teeth to be arranged directly on the external circumferential surface of the roller base member, for example by screwing or integral forming on the roller base member.

At the end-face end portions 113, 114 of the roller base member 101, the infeed roller 100 in each case has a bearing support device in the form of a respective bearing ring 105a,b, which bearing support device carries a respective bearing 106a,b for support of the roller base member 101. Depending on the embodiment, the bearings 106a,b may take the form of radial plain bearings, while at least one of the bearing devices may moreover comprise a thrust bearing for providing a predetermined axial play between the bearing rings and the roller base member.

As is apparent from FIG. 3, in the described embodiment, the illustrated left-hand bearing ring 105a projects only slightly into the interior of the roller base member 101, while the right-hand bearing ring 105b may extend into the roller base member 101 over at least half of the axial extent thereof and be configured to carry an assembly comprising an electric motor 110, a gearing 118 joined thereto and an input element in the form of an adapter ring 119 of a coupling device 117. Since the stated assembly is screwed to the second bearing ring via a circumferential connecting flange in the area of the gearing, the bearing ring 105b on the right-hand side in the figure may simultaneously be configured as a torque bracket. To this end, the bearing ring 105 has a radial flange 130 at its axial end face facing the gearing 118, to which radial flange said assembly is fixed via fastening bolts 131, which are screwed into an associated thread on the outer housing of the gearing 118. The radial flange 130 may be connected via a sleeve-type central portion 119 with the end-face portion, in particular by way of welding, to configure the bearing ring 105b on the right-hand side in FIG. 1.

In the described embodiment, the gearing 118 may comprise a planetary gear train, in which the sun gear is driven by the motor shaft of the electric motor 110 and in which an internal gear flange 140 constitutes the gear output. In this respect, the internal gear may be connected via the internal gear flange 140 with an adapter ring 109 as input part of the coupling device 117 using bolts 141. The coupling device 117 may moreover have one further ring element 108, which may be fastened as a driver ring in torque-transmitting manner, in particular in materially bonded or form-fitting manner, to the inside of the roller base member 101 and thus constitute the output side of the coupling device 117.

For torque-transmitting coupling of adapter ring 109 and driver ring 108 of the coupling device 117, a plurality of circumferentially spaced flexible, here for example cylindrical, coupling elements, in particular comprising an elastomer material, extending toward the axis E of the infeed roller 100 may be provided, which are fastened to one of the two rings 108, 109 and in each case extend through a respectively associated axially extending opening on the other ring. As is clear in particular from FIG. 4, provision may be made in the described embodiment for the elastomer coupling elements 122 to be fastened to the adapter ring 109 using a bolt joint, wherein, in the assembled state of the coupling, the coupling elements 122 extending in the axial direction project into associated feedthroughs on the driver ring 108 for torque-transmitting operative connection between the two ring elements 108, 109 of the coupling device 117. In the described embodiment, a plurality of such coupling elements 122 may be mounted in circumferentially spaced manner on the adapter ring 109, these extending, in the installation position, in each case into an associated feedthrough of the driver ring 108. In this respect, the gearing 117 may extend at least in places both through the driver ring 108 and through the adapter ring 109, which provides a compact construction of the drive device of the upper infeed roller of the shredding arrangement configured according to the invention or simplifies integration of the entire drive device within the roller base member.

The two end face portions 113, 114 of the infeed roller 100 are in each case closed by an associated cylinder lid 115a,b, these being screwed together with the respective bearing ring 105a,b. These cylinder lids 115a,b may have a fan opening for providing intended air cooling of the drive device, wherein one of the two cylinder lids 115a,b has an air inlet 111 and the other one of the cylinder lids has an air outlet 112 for providing an axial air current in the interior of the roller base member 101 of the infeed roller 100. Provision may be made for not only the driver ring 108 and the adapter ring but also the bearing rings 105a,b to comprise air passages 121, such that an air current generated outside the infeed roller 100 may be guided from the air inlet 111 to the air outlet 112. Through respective positioning, size and shape of the air inlet, the air outlet and the air passages, the air stream may be guided in targeted manner to components to be cooled of the drive device, for example to the gearing 180 and the electric motor 110 for at least partial absorption of the respective waste heat of the components of the drive device.

Supply and removal of the cooling medium is indicated for another embodiment in FIG. 2, which shows the respective air supply hose 42a and the air removal hose 42b.

Air supply or air removal is here not passed through the cylinder lids 115a,b in a direction perpendicular to axis E, but rather roughly perpendicular thereto, to prevent a component arrangement in the lateral direction.

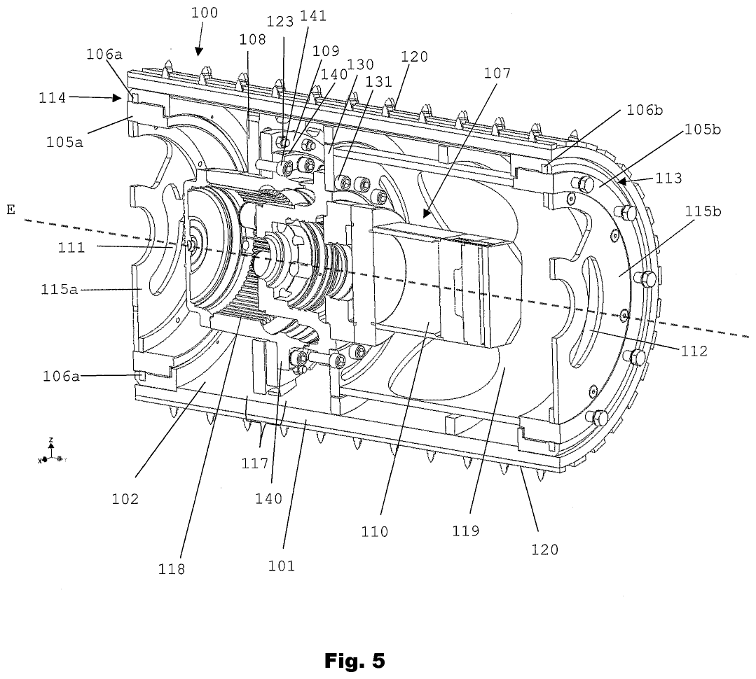

To mount the infeed roller 100, the gearing 118 may be connected at the internal gear flange 140 thereof with the adapter ring 109 and the coupling elements 122 fastened thereto using the fastening bolts 141, see FIGS. 3-5. Furthermore, the slip ring 105b may be connected with the end-face portion, comprising the bearing device 106b in particular in the form of plain bearing elements with the central portion 119 and the radial flange 130 and then the radial flange can be screwed to the gear train 118 using the bolts 131. Once the motor flange has been flange-mounted onto the gear train, this structural unit may be inserted axially as a whole into the roller base member 101, such that the coupling elements 122 engage, after circumferential orientation relative to the driver ring 108, into a respectively associated feedthrough of the driver ring to provide an operative connection between the electric motor 110 and the roller base member 101. The bearing ring 105b may then be fastened to the rocker housing 41, such that the roller member 101 is rotatably bearing-mounted relative to the rocker housing 41. The described design of the upper infeed roller of the shredding arrangement according to the invention enables simple mounting in that firstly the entire drive device excluding the driver ring 108 may be assembled outside the roller base member, wherein the infeed roller may then be finished by simple axial insertion of this assembly into the roller base member, which simplifies both the accessibility of individual components of the drive device of the upper infeed roller and also in principle the installation and/or maintenance thereof.

In the described embodiment, fastening of the individual drive component is achieved substantially by bolt screws, however any other means of connection may also be used, preferably in the form of detachable connections to simplify installation and maintenance, in particular the replacement of defective components.

### LIST OF REFERENCE SIGNS

1 Shredding arrangement
2 Shredding device
3 Supply device
20 Shredding rotor
22 Shredding tool
23 Machine frame
24a,b Side plate
25a,b Upper edge
30 Supply belt device
31 Belt drive
32a,b,c Lower infeed roller
33 Drive motor of lower infeed roller
40 Infeed rocker, rocker
41 Rocker housing
42a Air supply ports
42b Air removal ports
100 Infeed roller
101 Roller base member
102 Inside
105a,b Bearing support device, bearing ring
106a,b Bearing device
107 Drive device
108 First ring element or disk element, driver ring
109 Second ring element or disk element, adapter ring
110 Electric motor
111 Air inlet
112 Air outlet
113 End-face end portion
114 End face, end portion
115 Cylinder lid
117 Coupling device, coupling
118 Gearing
119 Central portion
120 Engaging strip
121 Air passage
122 Coupling element
130 Radial flange
131 Fastening bolts
140 Internal gear flange
141 Fastening bolts
E Axis of rotation of upper infeed roller
S Swivel axis
Z Supply device

What is claimed is:

1-14. (canceled)

15. A shredding arrangement for shredding material to be shredded, such as household waste, industrial waste, plastics, wood, paper and/or biomass, comprising a shredding device, which is arranged on a machine frame, and a supply device having at least one infeed roller drivable to rotate using an associated drive device for supplying the material to be shredded to the shredding device, wherein the infeed roller is configured to accommodate the associated drive device, and the drive device has an electric motor, a gearing, and a flexible coupling.

16. The shredding arrangement according to claim 15, wherein the infeed roller comprises a roller base member of hollow-cylindrical type accommodating the drive device.

17. The shredding arrangement according to claim 15, wherein the flexible coupling takes the form of an axially pluggable coupling and is joined on the input side to a driven side of the gearing.

18. The shredding arrangement according to claim 16, wherein the flexible coupling has a first ring element or disk element on the output side which is fastened to an inside of the roller base member, wherein the flexible coupling has a second ring element or disk element on the input side, and wherein first and second ring element or disk element are in operative connection for force and torque transmission using at least one flexible coupling element.

19. The shredding arrangement according to claim 18, wherein the gearing extends in sections axially through the first and second ring elements of the flexible coupling.

20. The shredding arrangement according to claim 16, wherein a bearing support device extending axially into the roller base member is arranged in each case in the region of longitudinal end portions of the roller base member, on which support device the roller base member is supported on its inside via a respective bearing device such as a plain bearing device.

21. The shredding arrangement according to claim 20, wherein the bearing support devices are fastened non-rotatably to the machine frame or non-rotatably to a rocker of the supply device which is arranged movably about a swivel axis relative to the machine frame for adaptation of an infeed or supply gap to the material to be shredded.

22. The shredding arrangement according to claim 20, wherein at least one of the bearing support devices takes the form of a bearing ring which carries the associated bearing device, in particular a bearing bush such as a plain bearing bush to support the roller base member relative to the bearing support device.

23. The shredding arrangement according to claim 20, wherein one of the bearing support devices is set up and configured to carry an assembly comprising the electric motor, the gearing, and a gear-side ring element or disk element of the flexible coupling.

24. The shredding arrangement according to claim 16, wherein a fan device is provided to dissipate waste heat of the drive device, in particular of the electric motor and/or of the gearing.

25. The shredding arrangement according to claim 24, wherein an air inlet is arranged at one end face of the roller base member and an air outlet is arranged at the other end face of the roller base member and the fan device is configured and arranged to generate a predetermined air throughput, in particular as a function of an actual value of the motor power, through the roller base member in the axial direction.

26. The shredding arrangement according to claim 21, wherein side plates running parallel to the supply direction are fastened to the machine frame in the region of the rocker, wherein the rocker is arranged swivelably in the transverse direction between these side plates in such a way that, when the rocker is in an operational position, the axis of rotation (E) of the infeed roller lies below an upper edge of the side plates.

27. The shredding arrangement according to claim 15, wherein the electric motor is powered by a frequency converter to provide an AC supply voltage with predetermined amplitude and frequency for establishing a predetermined speed of rotation and/or rotational acceleration of the infeed roller.

28. The shredding arrangement according to claim 15, wherein the shredding device comprises a shredding rotor driven by a further drive device, which shredding rotor has at least one shredding tool, in particular a plurality of shredding tools, at its circumference, wherein the shredding arrangement has a control device which controls the drive device of the shredding rotor and the drive device of the infeed roller for mutually coordinated supply and shredding of the material to be shredded.
